(19) United States
(12) Patent Application Publication
(10) Pub. No.: US 2008/0040219 A1
(43) Pub. Date: Feb. 14, 2008

(54) Proximity-based wireless advertising system

(76) Inventors: Jeff Kim, Fairfax, VA (US); Jean Meslie, Clifton, VA (US)

Correspondence Address: LITMAN LAW OFFICES, LTD., P.O. BOX 15035, CRYSTAL CITY STATION, ARLINGTON, VA, 22215, US

(21) Appl. No.: 11/819,116

(22) Filed: Jun. 25, 2007

Related U.S. Application Data
(60) Provisional application No. 60/836,634, filed on Aug. 9, 2006.

(51) Int. Cl. G06Q 30/00

(52) U.S. Cl. 705/14

(57) ABSTRACT

The proximity-based wireless advertising system includes a personal dedicated wireless electronics device that has display and alerting features. A wireless transceiver interacting with a web application over the internet or local area network can deliver marketing messages to the personal electronics device when a person carrying the device is at a location within the range of the wireless transceiver unit's signal. Advertising messages are delivered based on both the retailers' and customers' preferences. Retailers and advertisers can choose advertising preferences for their consumers by using a web application user interface. Software is provided that integrates with the retailer's point of sale software to electronically process any relevant coupons.

### CROSS-REFERENCE TO RELATED APPLICATION

This application claims the benefit of U.S. Provisional Patent Application Ser. No. 60/836,634, filed Aug. 9, 2006.

### BACKGROUND OF THE INVENTION

1. Field of the Invention

The present invention relates generally to wireless communications technologies, and more particularly, to a proximity-based wireless advertising system for providing localized, targeted advertising content to a wireless loyalty card held by a consumer.

2. Description of the Related Art

Communication systems having location-based applications that display surrounding points of interest are known in the art. Such communication systems generally determine a user's location and provide advertisements to the user for places near the user's location. Some location determining methods include having a Global Positioning System (GPS) receiver transmit location information of the user to the advertising content distributor. Other complex user location determining procedures may be employed using cellular wireless equipment, or the like.

Advertising is more effective when targeted to certain individuals, e.g., those known to have an interest in the advertised goods or services. Advertisers prefer to tailor advertising to a particular individual or group, such as direct mailings to people in a certain demographic or geographic area, or wireless transmissions to individuals fitting certain profiles known to the advertiser. This approach, however, raises privacy issues with individuals who may wish to remain anonymous or to limit distribution of their identity. Cell phone based technologies have not adequately addressed the privacy concerns of individuals. Realizing the problems introduced by cell phone based technologies, and that the century old paper coupon remains a hassle for shoppers, advertisers and retailers, there exists a need for a wireless marketing/loyalty solution that, while ensuring privacy concerns of the individual, is able to support true one to one personalization in stores, shopping malls, and the like.

Thus, a proximity-based wireless advertising system solving the aforementioned problems is desired.

### SUMMARY OF THE INVENTION

The proximity-based wireless advertising system includes a personal dedicated wireless electronics device that has display and alerting features. A wireless transceiver interacting with a web application over the internet or local area network can deliver marketing messages to a wireless loyalty card when a person carrying the card is at a location within the range of the wireless transceiver's signal. Advertising messages are delivered based on retailer and customer preferences. Retailers and advertisers can choose advertising preferences for their consumers by using a web application user interface. Software is provided that integrates with the retailer's point of sale software to electronically process any relevant coupons.

These and other features of the present invention will become readily apparent upon further review of the following specification and drawings.

### BRIEF DESCRIPTION OF THE DRAWINGS

FIG. 1A is an environmental, front perspective view of a wireless loyalty card in a proximity-based wireless advertising system according to the present invention.

FIG. 1B is an environmental, rear perspective view of a wireless loyalty card in proximity-based wireless advertising system according to the present invention.

FIG. 2 is a block diagram showing functional interfaces of the proximity-based wireless advertising system according to the present invention.

FIG. 3 is a block diagram showing a layer architecture of the proximity-based wireless advertising system according to the present invention.

FIG. 4 is a block diagram showing call flow in the proximity-based wireless advertising system according to the present invention.

FIG. 5 is a Point of Sale (POS) flow diagram of the retailer POS API portion of the proximity-based wireless advertising system according to the present invention.

FIG. 6 is a block diagram showing wireless loyalty card firmware of the proximity-based wireless advertising system according to the present invention.

FIG. 7 is a block diagram showing wireless message broadcaster firmware of the proximity-based wireless advertising system according to the present invention.

FIG. 8 is a block diagram of an air packet format of the proximity-based wireless advertising system according to the present invention.

FIG. 9 is a screen shot of a shopper preference managing page of the proximity-based wireless advertising system according to the present invention.

FIG. 10 is a screen shot of an advertiser campaign managing page of the proximity-based wireless advertising system according to the present invention.

Similar reference characters denote corresponding features consistently throughout the attached drawings.

### DETAILED DESCRIPTION OF THE PREFERRED EMBODIMENT

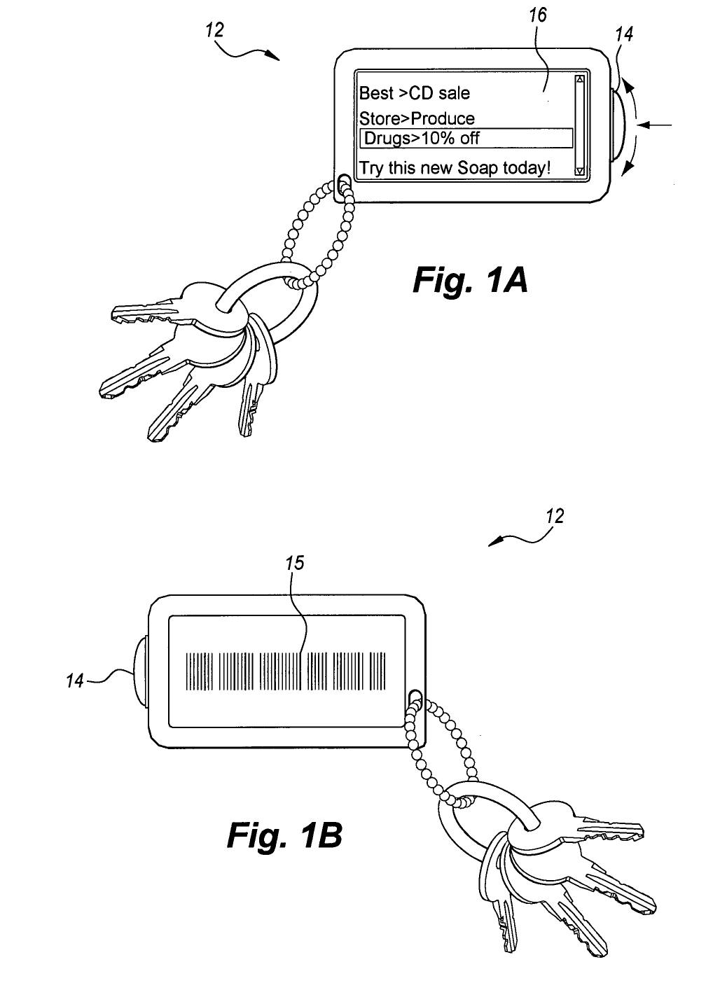

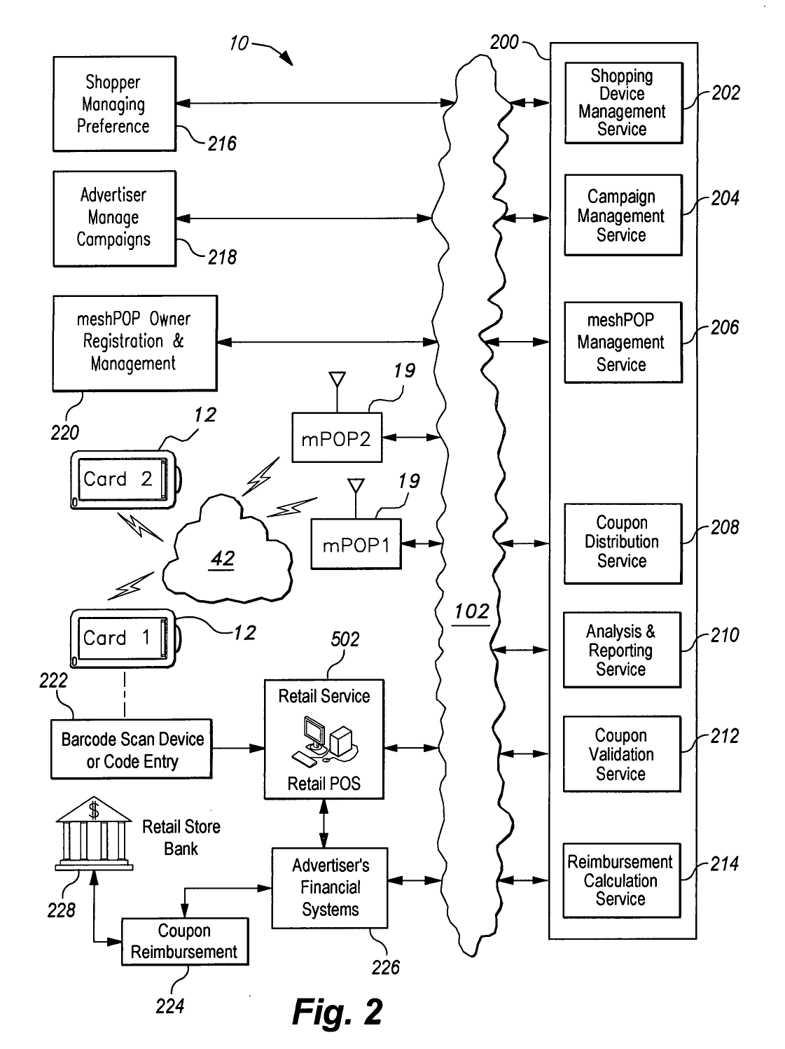

The present invention is a proximity-based wireless advertising system 10. The system comprises a web application, a wireless transceiver and a personal electronics device for presenting alerts about advertisements, coupons, or promotional offers. The wireless transceiver may be used to create a Wireless Personal Area Network (WPAN), which can be provided for use by at least one retailer or advertiser. As shown in FIGS. 1a-2, advantageously, the system may provide mesh networking via a plurality of wireless loyalty cards 12 held by a plurality of users as a way to route data, voice and instructions between various point of presence (POP) nodes, i.e., meshCasters 19. A mesh network configuration allows for continuous connections and reconfiguration around broken or blocked paths by “hopping” from node to node until the destination is reached. The meshPOP 19 creates a robust and inexpensive infrastructure for the dissemination of localized, personalized advertising content. It is within contemplation of the present invention to use other network topologies, such as, e.g., star, hybrid mesh/star, or the like. Regardless of network topology used, the consumer is provided with a wireless loyalty card 12. Thus advantageously, the consumer will receive alerts on the wireless loyalty card 12 when he/she is in a location that is within wireless range of at least one other wireless transceiver, preferably a message broadcaster 19 (meshCaster). The system also contains integration with the retailer's point of sale software (POS) so that coupons are automatically added to the consumer's wireless loyalty card 12 when the consumer purchases relevant items.

As shown in FIGS 1A-1B, and 2, the wireless loyalty card 12 of the present invention is electrically (battery) powered and comprises a display screen 16 and settings such as message navigation, sound on/off, scroll up/down and select, the settings being accessed via a combination slider and pushbutton switch 14. A barcode 15 may be included on the card 12 to uniquely identify the card 12. The unique identification number of the card 12 may be automatically transmitted to a system server 200 when the card is in wireless range of a message broadcaster 19. The electronics device employs low power wireless technology such as, e.g., IEEE 802.15.4 for communication. IEEE 802.15.4-2003 (Low Rate WPAN) deals with low data rate but very long battery life (months or even years) and very low complexity.

A ZigBee® set of high level communication protocols is based upon the specification produced by the IEEE 802.15.4 taskgroup. Preferably, the ZigBee® communications protocol is utilized for the broadcast radio transceivers and loyalty card radio transceivers, according to the present invention. Additionally, the present invention contemplates the use of other communications protocols such as Wibree®, or the like.

Advantageously, by using the IEEE 802.15.4 communications protocol, secure, reliable communications and/or high precision ranging/locating capability (1 meter accuracy and better), can be used. The low rate (LR approximately 20 kb/s to approximately 250 kb/s), and ultra low power features provided by compliance of the system 10 with IEEE 802.15.4 advantageously results in lower power consumption, lower cost, and longer battery life of the system components, particularly of wireless loyalty card 12.

Moreover, the system may utilize an unlicensed portion of the radio frequency band and may transmit signals comprising, but not limited to, an ultra wideband (UWB) Radio (operating in unlicensed UWB spectrum), a Chirp Spread Spectrum (operating in unlicensed 2.4 GHz spectrum), or the like. Moreover, the range of operation of the low power radio technology used by the present invention is preferably no greater than approximately 100 m.

Irrespective of a specific physical (PHY) transmission protocol used, each wireless loyalty card 12 is provided with a unique identifier in order to identify the consumer in possession of the wireless loyalty card 12. The wireless loyalty card 12 includes barcode 15 disposed on the back of the card 12 and associated with unique identification of the card 12. Additionally the system 10 will allow consumers to exchange information between wireless loyalty cards 12 using the aforementioned low power radio technology. As shown in FIGS. 1A-1B, the wireless loyalty card 12 has a display, such as, e.g. liquid crystal display 16. The display 16 is capable of displaying text and simple graphical information concerning a specific deal offered by an advertiser to the consumer. A user input device is provided, and may be a three way, spring return contact switch 14 as shown in FIGS. 1A-1B. The loyalty card 12 may have a thin form factor and may be in the shape of a key fob as shown, or any other small, easily handled shape.

Alternatively, functionality of wireless loyalty card 12 may be embedded in another type of mobile device, such as for example, cell phone, PDA, smart phone, laptop computer, notebook computer, mini-notebook computer, or the like. When loyalty card features are incorporated in such devices, it is contemplated by the present invention to use the same low power wireless technology available to the wireless loyalty card 12 in order to receive the proximity based advertisements of system 10.

When the wireless loyalty card features of the current invention 10 are provided on mobile handsets or other personal mobile devices proximity based advertisements are still received without using cellular or GPRS technologies. When embedded in another mobile device, the display and some processing may be shared with other applications embedded in the mobile device. However, such sharing of resources will not affect the low power, proximity communication according to the present invention. Moreover, the mobile device may have a barcode 15 or some other means of uniquely identifying the device to the system 10, such as, for example, an IrDA (infra red) transmitter, an RFID (Radio Frequency Identification) transponder, or the like.

The message broadcasting transceiver (meshPOP) 19 of the present invention can transmit messages to the wireless loyalty card 12, or to the alternative personal devices mentioned above using the aforementioned low power wireless technology. The message broadcasting transceiver 19 can also receive messages from devices such as wireless loyalty card 12 and send the message back to a web application residing on server 200 via Internet cloud 102. The messages transmitted by message broadcasting transceiver 19 are controlled by specific web applications on server 200, such as, e.g. Coupon Distribution Service 208. Message broadcasting transceiver 19 can have LAN or WWAN connectivity to the server 200 using traditional computer networking methods. The web application may reside on server that is accessed through the Internet or through the LAN.

The wireless loyalty card 12 and the message broadcasting transceiver 19 preferably use an unlicensed radio frequency for communication.

As shown in FIG. 2, the web applications reside in at least one server 200 capable of being accessed over the Internet through a hosting website or within a local area network of the message broadcasting transceiver 19. A web application, such as Campaign Management Service 204, may be provided to allow the retailers to manage and track their advertisements. Retailers may access a campaign managing user interface 218 to complete campaign management tasks accepted by the Campaign Management Service 204.

A web application, such as Shopping Device Management Service 202, may be provided to allow the consumers to personalize their wireless loyalty cards 12. Shoppers may access a shopper managing preference user interface 216 to complete personalization tasks accepted by the Shopping Device Management Service 202. The shopping device management service 202 is provided to allow a consumer to manage preference such as what type of messages the consumer is interested in and how the consumer would like to be notified.

A meshPOP management service 206 allows merchants/advertisers who have installed a message broadcasting transceiver 19 to set preferences such as message type, time of message distribution, and to which devices the message should be distributed. An owner registration and management user interface 220 may be provided to input registration data into the meshPOP management service 206. The meshPOP management service 206 also provides the merchant/advertiser with performance monitoring and performance reporting of the message broadcasting transceiver 19.

The campaign management service 204 allows the advertisers to create advertising campaigns and manage and track the effectiveness of the campaign.

The coupon distribution service 208 matches the consumer preferences with targeting parameters defined by the advertisers. Based on the consumer preferences and targeting parameters matches appropriate messages and delivery times are queued up for users associated with the matches.

The coupon validation service 212 interacts with the retailers POS system 502 and validates if the coupon is valid for the user associated with a particular transaction at the POS 502.

The reimbursement calculation service 214 gathers all redeemed coupons from retailers and routes them to a financial system 226 of the appropriate advertiser so the advertiser will have sufficient information to process the payment via coupon reimbursement 224 to the retailer via the retailer's bank 228.

The analysis and reporting service 210 mines ad delivery data and POS transaction data, identifies correlation between the datasets and creates an advertisement effectiveness matrix 999. The analysis and reporting service 210 can also provide financial auditing information to the retailer or the advertisers.

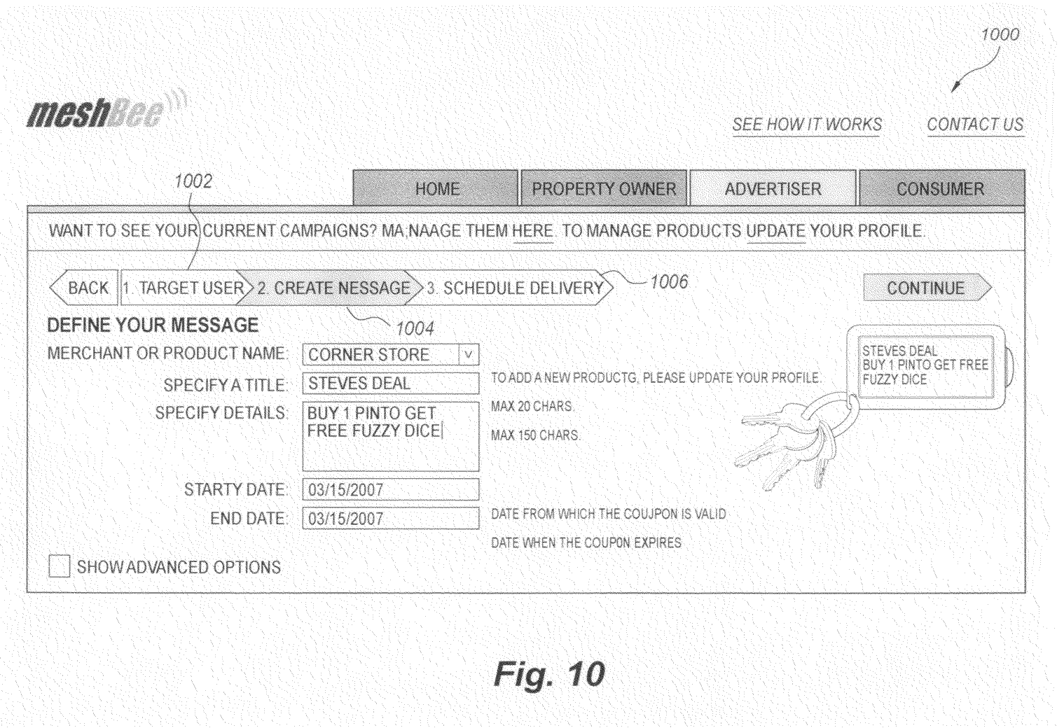

Retailers log onto an application running on server 200, register and select their advertising preferences, which primarily includes an option to specify a location where the advertisements are to be distributed. Additionally, options for specifying time and day of distribution, identifying the advertisements with a specific category, and specifying a target group of consumers to distribute the advertisements can be included. The retailers are guided through a plurality of relevant web pages, such as for example, web page 1000, as shown in FIG. 10, for selecting these options.

The web application can interact with the advertiser's systems using web-services to automatically receive the advertisements from the advertisers and provide reporting data back to the advertisers.

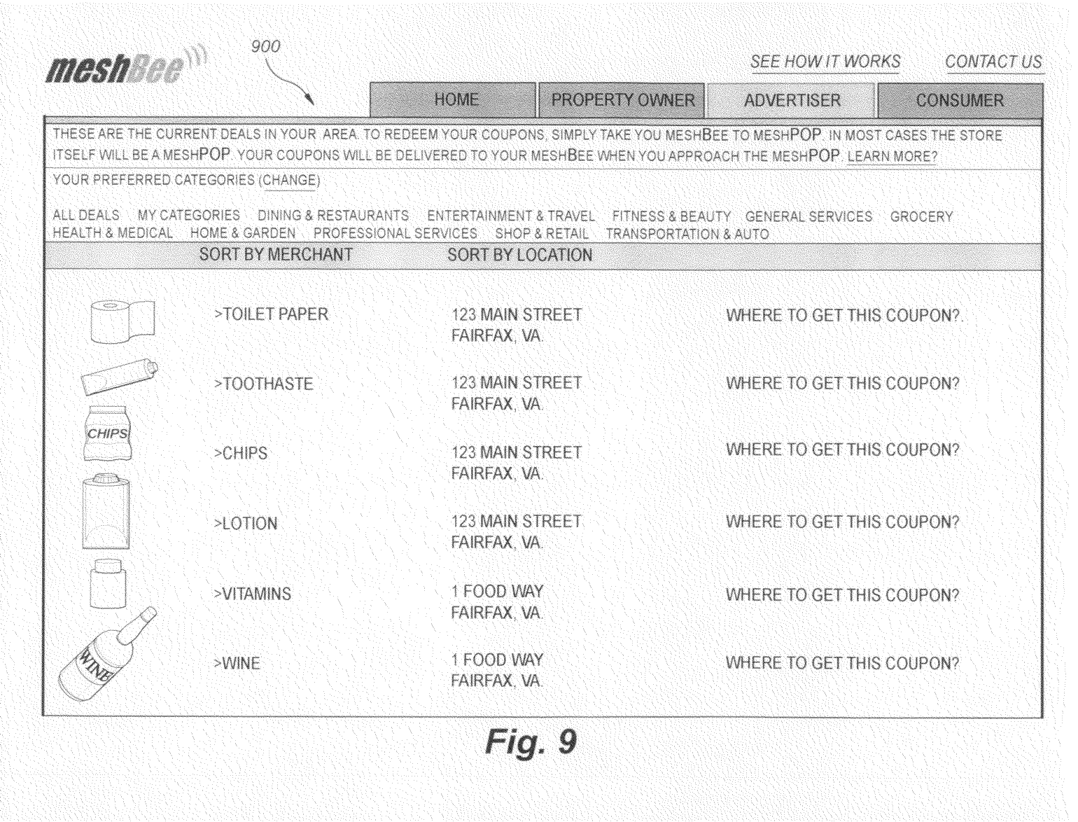

Similarly, consumers can log onto the hosting website 200 for defining their preferences. The consumers are provided with a plurality of web pages, such as for example, web page 900, as shown in FIG. 9, having various selectable options. These customer selectable options comprise selection of retailers or stores from which they intend to receive the advertisements and their preferred category of advertisements. Options to specify locations where the consumers would like to receive the advertisements are also provided. Consumers are also provided with options to choose the method of receiving the advertisements on their wireless loyalty cards 12, for example, by an audible alert followed by visual display of the advertisement message. Depending on the capability of wireless device 12, consumers may also specify different types of alerts according to the advertisement categories and retailers or stores.

As contemplated by the present invention, the system 10 may have the capability to learn from the users shopping behavior and customize the advertisements delivered to the user.

Web applications residing on the server 200 may further comprise scalable, machine independent software applications and engines which can efficiently distribute and track advertisements in a single server environment such as server 200, or in a distributed processing environment having a plurality of servers.

The message broadcasting transceiver 19 provides a gateway between web applications of server 200 and the wireless loyalty card 12. Wireless loyalty cards 12 and message broadcasting transceivers 19 communicate wirelessly via wireless network 42. The message broadcasting transceiver 19 interacts with the server over the Internet and communicates wirelessly with the wireless loyalty card 12. Relevant advertising messages are delivered to wireless loyalty cards 12 when they are within a signal range of the message broadcasting transceiver 19. The message broadcasting transceiver 19 also receives acknowledgement messages from wireless loyalty cards 12 and communicates the messages to servers, such as server 200.

A user having the wireless loyalty card 12 receives an alert from the card 12 when the user is at a location that is within the target area of an advertising message. Messages delivered to a specific card 12 are filtered based on the user preference and other relevant information defined by advertisers and user behavior. If the user does not define any preferences the system 10 filters based only on targeting rules. Messages are automatically deleted once an advertisement is expired.

Based on acknowledgement messages sent by message broadcasting transceivers 19, retailers, by logging onto the hosting server 200, can know the number of times an advertisement is delivered to wireless loyalty cards 12 and can also know the number of users who actually viewed the details of a particular advertisement. If the retailer participates in a loyalty program or the POS software integration of POS terminal software 502 and coupon engine 312, the number of impressions that turned into sales can also be tracked.

At the time of sale, retailers can capture the unique ID of the wireless loyalty card 12 by scanning the barcode printed on the card 12 with a scanning device 222 and providing this information back to the server 200. The coupon validation service 212 compares the shopping transaction with all the messages that are delivered to the user and returns any valid coupons for the shopping transaction. The POS application 502 issues proper credits to the user for any valid coupons returned by the coupon validation service 212.

The coupon validation service 212 validates the coupons by retrieving all the messages that was delivered to the device and not yet expired. Then it checks all items purchased in the specific shopping transaction. If any of the purchased items is associated with the messages that are delivered to the user and still valid, the coupon code associated with the message will be returned to the POS software 502. The POS software 502 acknowledges the receipt of the coupon codes and issues credit to the user.

The analysis and reporting service 210 keeps an audit track of all the transactions and periodically sends the details of the transaction to the advertisers. The advertisers can use this information to validate the coupon reimbursement request from the retailer and pay for the coupons electronically.

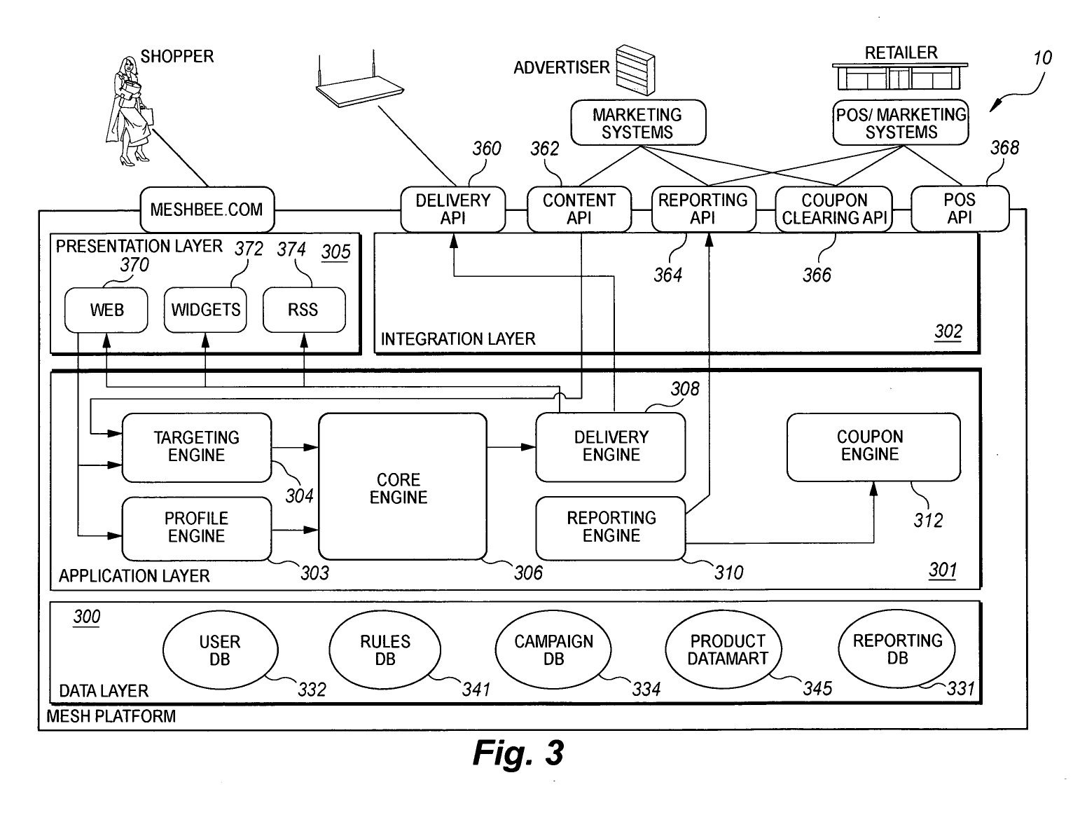

As shown in FIG. 3, the system protocol 300 of the wireless advertising system 10 is based on a plurality of abstraction layers which may include a data layer 300, an application layer 301, an integration layer 302, and a presentation layer 305. Residing in the data layer 300 are user database 332, rules database 341, campaign database 334, product database 345, and reporting database 331. These databases are repositories for all of the data required for operation of the wireless advertising system 10. Above the data layer 300, application layer 301 provides for the processing engines required by the advertising system 10.

Processing engines such as the targeting engine 304, the profile engine 303, the core engine 306, delivery engine 308, reporting engine 310 and coupon engine 301 mediate between the data layer 300 and presentation layer 305 as well as integration layer 302.

At the presentation layer 305, data is transformed to provide a standard interface for the application layer 301. The presentation layer comprises web presentation software 370, widgets presentation software 372 and RSS presentation software 374. All presentation software may interface with a website (meshbee.com™) of the proximity-based wireless advertising system 10. For example, web 370 may transform HTML data or the like, widgets 372 may transform Flash® data, JavaScript® data or the like, while RSS 374 may transform web feed data for dynamic content updates, and the like.

Integration layer 302 provides a layer between the application programming interfaces (API) and their respective engines in the application layer 301. The APIs accept data from the users of advertising system 10, such as shoppers, wireless network 42, advertisers and their marketing systems, retailers and their marketing systems, and the like. Therefore, preferably the wireless network 42 exchanges data with the delivery API 360. Advertiser/retailer marketing systems exchange data with a content API 362, a reporting API 364, a coupon clearing API 366, and a point of sale API 368.

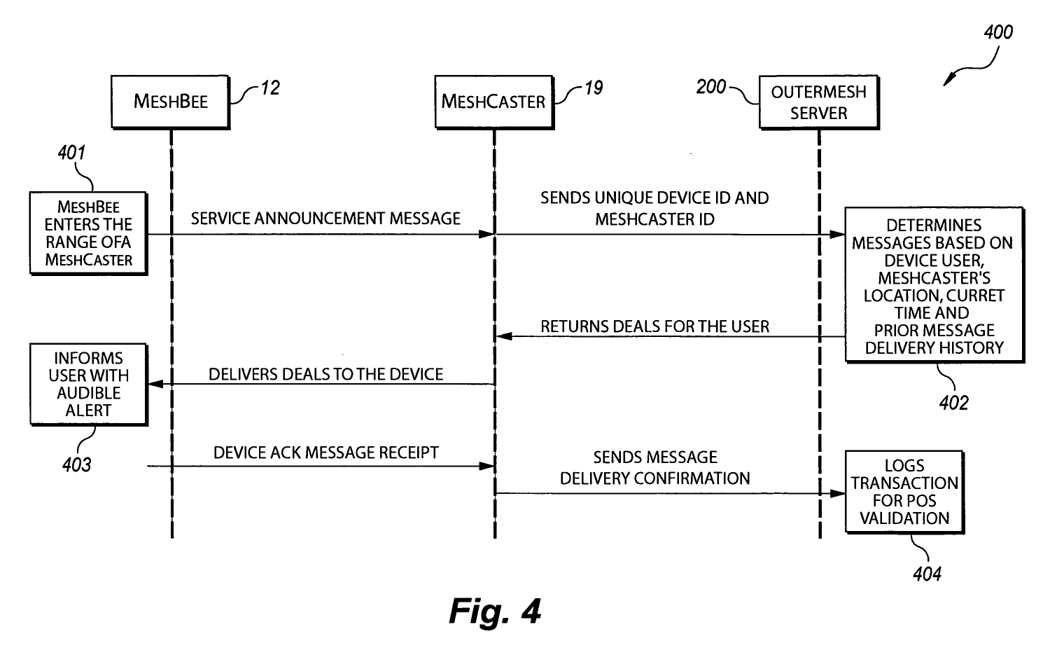

Referring now to messaging protocol 400 of FIG. 4, as shown at step 401, messaging among system components such as wireless loyalty card 12, message broadcaster 19 and server 200 is initiated only when the wireless loyalty card 12 enters the range of a message broadcaster 19. When range entry occurs, the wireless loyalty card 12 sends a service announcement message to the message broadcaster 19. The message broadcaster 19 then sends the unique device ID of the message broadcaster 19 as well as the ID of the wireless loyalty card 12 to the server 200. As shown at step 402, the server determines messages based on the user of the card 12, the location of the message broadcaster 19, the current time, and a prior message delivery history. “Deal” messages are then sent by the server 200 to the message broadcaster 19 for wireless relay back to the wireless loyalty card 12. As shown at step 403, the wireless loyalty card 12 informs the user of the “deal” messages with an audible alert. The wireless loyalty card 12 then sends a message received acknowledgment (ACK) to the message broadcaster 19, confirmation of which is forwarded by the message broadcaster 19 to the server 200. As shown at step 404, the server 200 then logs the transaction for point of sale (POS) validation.

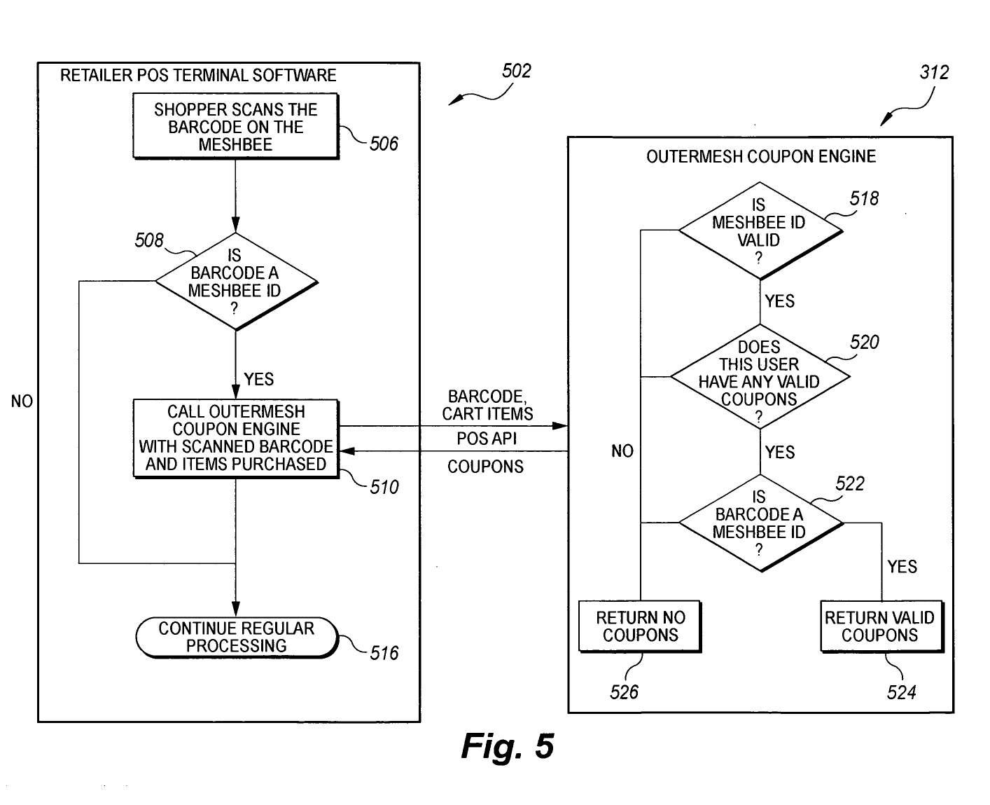

As shown in FIG. 5, the retailer POS terminal 502 can be programmed to exchange information via a communications channel with the coupon engine 312 residing in the coupon validation service 212 in order to uniquely identify the wireless loyalty card 12 to the coupon engine 312 and to accept valid coupons from the coupon engine 312. For example, at step 506 a shopper scans the barcode 15 located on wireless loyalty card 12. At step 508 the POS software 502 determines whether the barcode is an ID of a wireless loyalty card 12. If not, then regular processing resumes at step 516, otherwise, as shown at step 510, a communication channel is opened to the coupon engine 312 and the barcode 15 along with a list of purchased items is sent to the coupon engine 312. At step 518 the coupon engine determines whether the barcode 15 is valid, and, as shown in step 526 returns no coupons if the barcode 15 is invalid. Otherwise, at step 520 if the user has any valid coupons, and, as shown at step 522 the barcode must be an ID of a wireless loyalty card 12 then, as shown in step 524, valid coupons are returned to the POS 502 via the opened communication channel.

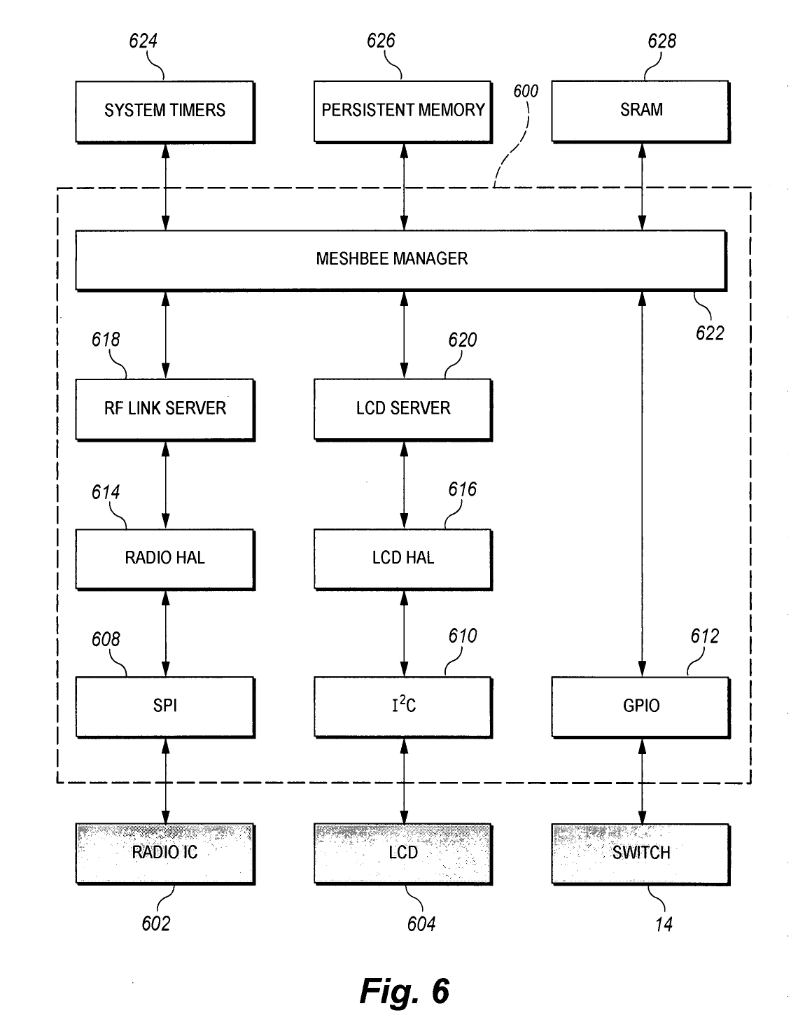

As shown in FIG. 6, the wireless loyalty card 12 has firmware architecture in processor 600 that is designed to manage a radio transceiver chip 602, a display chip 604, and a user interface switch 14 while also minimizing space and power requirements. Management software 622 of wireless loyalty card 12 is connected to resources such as, e.g., system timers 624, persistent memory 626, and static random access memory (SRAM) 628.

Manager 622 of card 12 controls radio 602 via radio management layers which include a serial peripheral interface (SPI) 608, a radio hardware extraction layer (radio HAL) 614, and an RF link server 618.

Manager 622 of card 12 controls LCD 604 via display management layers which include an inter-integrated circuit interface (I²C) 610, an LCD hardware abstraction layer (LCD HAL) 616, and an LCD server 620. Additionally, the card Manager 622 reads the various states of switch 14 via a general purpose input output interface (GPIO) bus 612.

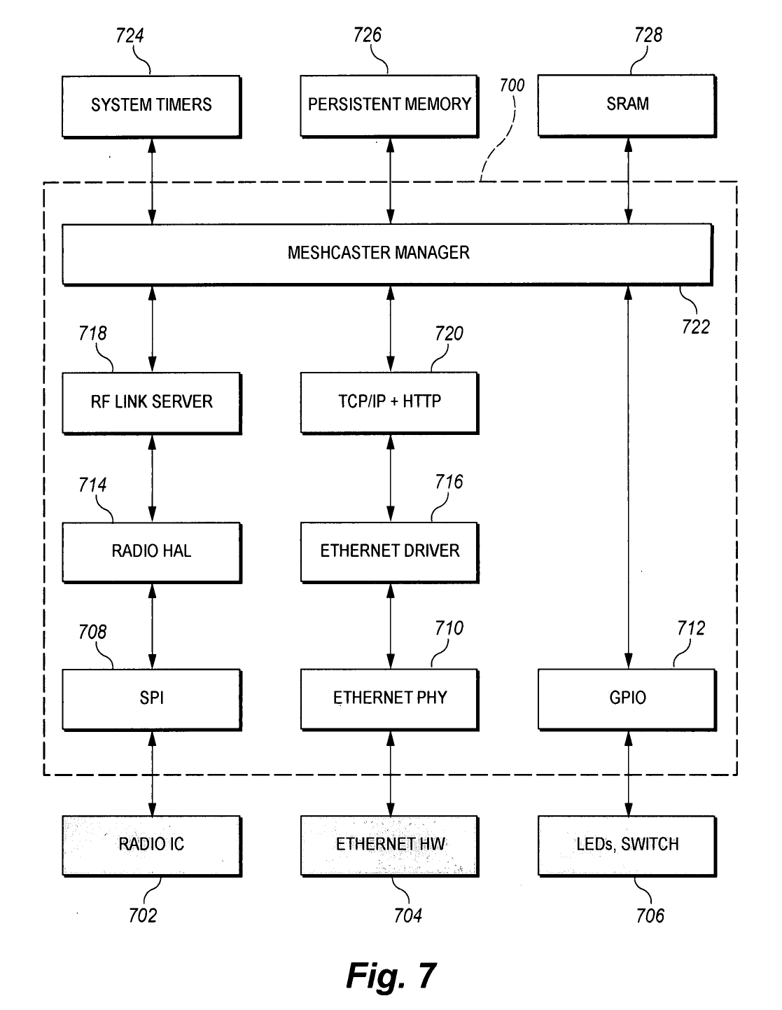

As shown in FIG. 7, the message broadcasting transceiver 19 has firmware architecture in processor 700 that is designed to manage a radio transceiver chip 702, Ethernet hardware suite 704, and a user interface 706 comprised of switch and status lights. Management software 722 of message broadcasting transceiver 19 is connected to resources such as, e.g., system timers 724, persistent memory 726, and static random access memory (SRAM) 728.

Manager 722 of message broadcasting transceiver 19 controls radio 702 via radio management layers which include a serial peripheral interface (SPI) 708, a radio hardware abstraction layer (radio HAL) 714, and an RF link server 718.

Manager 722 of message broadcasting transceiver 19 controls Ethernet HW 704 via ethernet management layers which include an Ethernet PHY (physical layer) 710, an Ethernet driver 716, and a protocol layer 720. Additionally, the broadcast transceiver Manager 722 reads and writes data to ‘lights and switch’ 706 via a general purpose input output interface (GPIO) bus 712.

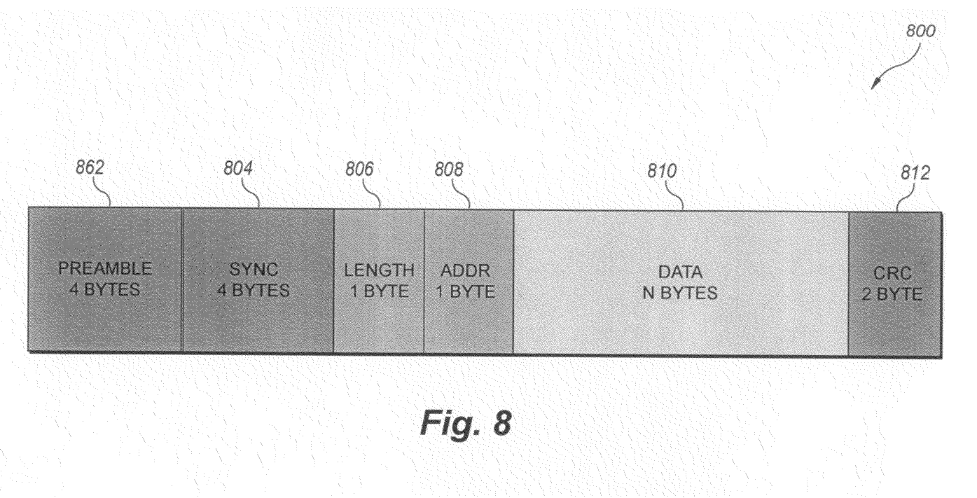

As shown in FIG. 8, the present invention provides a compact data packet 800 with error checking capability. Design of data packet 800 facilitates the preferably low rate (LR) wireless network configuration of proximity-based wireless advertising system 10. The data packet 800 preferably includes a 4 byte preamble 862, a 4 byte synchronization code 804, a 1 byte length field 806, a 1 byte address field 808, and ‘N’ bytes of payload 810 depending on the length specified in the length field 806. Additionally, a 2 byte cyclic redundancy check field 812 (CRC) is provided for error checking capability.

As shown in FIG. 9, the consumer presentation web page 900 allows the consumer to sort “deals” by merchant or sort “deals” by location. As shown in FIG. 10, the campaign management web page 1000 allows a merchant to enter a product name, specify a “deal” title, specify deal details, and specify start and end dates. As shown in FIG. 9, web page 1000 provides a user targeting interface 1002, a message creation interface 1004, and a message delivery scheduling interface 1006.

The proximity-based wireless advertising system 10 of the present invention supplements existing marketing campaigns or loyalty programs by enabling a new real-time touch point between businesses and their prospects and customers. Businesses can use the web applications on server 200 to set up marketing campaigns and have the flexibility to broadcast to a single recipient, wide audience or specific groups. Businesses can run special deals and coupons in real time, allowing them to clear inventory at lower rates or attract new customers during slow times.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is to be understood that the present invention is not limited to the embodiment described above, but encompasses any and all embodiments within the scope of the following claims.

We claim:

1. A proximity-based wireless system for delivering advertising messages to a consumer, the system comprising:
a wireless loyalty card for use by the consumer, the wireless loyalty card having means for alerting the consumer about a received advertising message, means for displaying the received advertising message to the consumer, and means for uniquely identifying the card to the system and at a Point of Sale of a retailer;
means for distributing to the consumer a personalized loyalty offering for display on the loyalty card;
means for redeeming the personalized loyalty offering based on a result from the unique card identifying means at the retailer's Point of Sale terminal; and
means for wirelessly transmitting the advertising messages to the wireless loyalty card only when the consumer is in close proximity to the retailer;
wherein the wireless loyalty card alerts the consumer about a received advertising message and displays the received advertising message to the consumer.

2. The proximity-based wireless advertising system according to claim 1, wherein an effective range of wireless message communication is up to about one hundred meters.

3. The proximity-based wireless advertising system according to claim 1, wherein the system employs a wireless network in a mesh topology.

4. The proximity-based wireless advertising system according to claim 1, wherein the system employs a wireless network in a star topology.

5. The proximity-based wireless advertising system according to claim 1, wherein the system employs a wireless network in a hybrid mesh/star topology.

6. The proximity-based wireless advertising system according to claim 1, wherein the system employs a low rate wireless personal area network for wireless communication of the advertising messages.

7. The proximity-based wireless advertising system according to claim 1, further comprising: means for targeting and filtering messages for each consumer and device based on association of the unique card identification to consumer and system preferences.

8. The proximity-based wireless advertising system according to claim 1, further comprising: an electronic coupon clearing system, the electronic coupon clearing system having means for validating the delivery of a coupon to a given consumer and a subsequent purchase of a product.

9. The proximity-based wireless advertising system according to claim 8, wherein the coupon clearing system provides auditing information to the advertiser for reimbursement for the redeemed coupons at a retail store.

10. The proximity-based wireless advertising system according to claim 1, further comprising:
means for auditing an advertising campaign; and
means for tracking an advertising campaign; and
whereby advertisers monitor and track the performance of their advertising campaigns.

11. A proximity-based wireless system for delivering advertising messages to a consumer, the system comprising:
a wireless loyalty card for use by the consumer, the wireless loyalty card having means for alerting the consumer about a received advertising message, means for displaying the received advertising message to the consumer, means for uniquely identifying the card to the system, and a barcode for uniquely identifying the card at a Point of Sale of a retailer; means for distributing to the consumer a personalized loyalty offering for display on the loyalty card;
means for redeeming the personalized loyalty offering based on a scan of the barcode at the retailer's Point of Sale terminal; and
means for wirelessly transmitting the advertising messages to the wireless loyalty card only when the consumer is in close proximity to the retailer; and
wherein the wireless loyalty card alerts the consumer about a received advertising message and displays the received advertising message to the consumer.

12. The proximity-based wireless advertising system according to claim 11, wherein an effective range of wireless message communication is up to about one hundred meters.

13. The proximity-based wireless advertising system according to claim 11, wherein the system employs a wireless network in a mesh topology.

14. The proximity-based wireless advertising system according to claim 11, wherein the system employs a wireless network in a star topology.

15. The proximity-based wireless advertising system according to claim 11, wherein the system employs a wireless network in a hybrid mesh/star topology.

16. The proximity-based wireless advertising system according to claim 11, wherein the system employs a low rate wireless personal area network for wireless communication of the advertising messages.

17. The proximity-based wireless advertising system according to claim 11, further comprising: means for targeting and filtering messages for each consumer/device based on association of the unique card identification to consumer and system preferences.

18. The proximity-based wireless advertising system according to claim 11, further comprising: an electronic coupon clearing system, the electronic coupon clearing system having means for validating the delivery of a coupon to a given consumer and a subsequent purchase of a product.

19. The proximity-based wireless advertising system according to claim 18, wherein the coupon clearing system has means for providing auditing information to the advertiser to reimburse for the redeemed coupons at a retail store.

20. A proximity-based wireless system for delivering advertising messages to a consumer, the system comprising:
a portable wireless electronic device for use by the consumer, the wireless device having a range of up to one hundred meters for receiving the advertising messages, the wireless device having means for alerting the consumer about a received advertising message, the wireless device having means for displaying the received advertising message to the consumer, means for uniquely identifying the portable wireless electronic device to the system; and means for uniquely identifying the portable wireless electronic device at a Point of Sale of a retailer;
means for distributing to the consumer a personalized loyalty offering for display on the wireless electronic device;
means for redeeming the personalized loyalty offering based on a result from the unique card identifying means at the retailer's Point of Sale terminal; and
means for wirelessly transmitting the advertising messages to the wireless electronic device only when the consumer is in close proximity to the retailer;
wherein the wireless electronic device alerts the consumer about a received advertising message and displays the received advertising message to the consumer.
